(19) United States
(12) Patent Application Publication
(10) Pub. No.: US 2021/0289825 A1
(43) Pub. Date: Sep. 23, 2021

(54) BLOWOUT SUPPRESSING AGENT FOR DEEP FRIED FOOD, METHOD FOR SUPPRESSING BLOWOUT AND DEEP FRIED FOOD

(71) Applicant: J-OIL MILLS, INC., Tokyo (JP)

(72) Inventors: Junpei KUBOTA, Tokyo (JP); Keiko YAMAKU, Tokyo (JP); Tomoki HORIGANE, Tokyo (JP); Sanshiro SAITO, Tokyo (JP)

(21) Appl. No.: 17/263,740

(22) PCT Filed: Aug. 1, 2019
(86) PCT No.: PCT/JP2019/030202

§ 371 Date: Jan. 27, 2021

(30) Foreign Application Priority Data
Aug. 10, 2018 (JP) 2018-151334

(51) Int. Cl. A23L 29/212; A21D 10/04; A21D 13/60; A21D 15/02

(52) U.S. Cl. CPC A23L 29/212; A21D 15/02; A21D 13/60; A21D 10/04

(57) ABSTRACT

A blowout suppressing agent for a deep fried food includes a component A satisfying conditions of (1) to (4) below: (1) a starch content is equal to or more than 75% by mass; (2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴, (3) a degree of swelling in cold water at 25° C. is equal to or more than 5 and equal to or less than 20, and (4) a content on a sieve having a mesh size of 0.075 mm and under a sieve having a mesh size of 0.5 mm is equal to or more than 30% by mass and equal to or less than 100% by mass.

### TECHNICAL FIELD

The present invention relates to a method for suppressing a blowout during deep frying of a food, and more specifically, a blowout suppressing agent for a deep fried food, a method for suppressing a blowout, a deep fried food, and a composition.

### BACKGROUND ART

In general, it is known that, during deep frying of a cream croquette, a potato croquette, a curry bread, an apple pie, a custard cream pie, and the like, a phenomenon that a batter bursts and a filling pops out, so-called a blowout, is likely to occur. When the blowout occurs, there is a risk that a frying oil will splash and cause a cook to be burned. Also, there is a problem that the finished deep fried food does not look good.

Therefore, various methods have been conventionally studied to suppress the blowout.

Patent Document 1 describes that, in order to suppress the blowout, the blowout during deep frying or during heating by a microwave oven is suppressed by kneading an emulsified oil and fat composition, formed of an aqueous phase portion in which protein and starch are mixed in a liquid sugar and an oil phase portion containing an emulsifier, into a filling of croquettes or deep fried pies.

Patent Document 2 suggests that a blowout during deep frying can be reduced by using starch, treated with a starch hydrolase or a glycosvltransferase on swelling-suppressed starch that has been subjected to a crosslinking treatment such as phosphate crosslinking, for filling cream croquettes or curry fillings.

### RELATED DOCUMENT

### Patent Document

[Patent Document 1] Japanese Unexamined Patent Publication No. 2001-245588

[Patent Document 2] Japanese Unexamined Patent Publication No. 2013-198479

### SUMMARY OF THE INVENTION

### Technical Problem

However, a method for suppressing a blowout in the related art is insufficient, and is required to be further improved.

Therefore, an object of the present invention is to provide a blowout suppressing agent, a method for suppressing a blowout, a deep fried food, and a composition which are capable of achieving an excellent meltability in mouth and suppressing an occurrence of a blowout during frying.

### Solution to Problem

A blowout suppressing agent for a deep fried food of the present. invention contains a component A satisfying conditions of (1) to (4) below.

(1) A starch content is equal to or more than 75% by mass

(2) Equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴

(3) A degree of swelling in cold water at 25° C. is equal to or more than 5 and equal to or less than 20

(4) A content on a sieve having a mesh size of 0.075 mm and under a sieve having a mesh size of 0.5 mm is equal to or more than 30% by mass and equal to or less than 100% by mass

In addition, the blowout suppressing agent for a deep fried food may further contain phosphoric acid crosslinked starch.

Furthermore, in the blowout suppressing agent for a deep fried food, a mass of the phosphoric acid crosslinked starch may be equal to or more than 0.1 times and equal to or less than 1 time a mass of the component A.

A method for suppressing a blowout of a deep fried food of the present invention includes incorporating a component A satisfying conditions of (1) to (4) below into a filling of the deep fried food.

(1) A starch content is equal to or more than 75% by mass

(2) Equal co or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴

(3) A degree of swelling in cold water at 25° C. is equal to or more than 5 and equal to or less than 20

(4) A content on a sieve having a mesh size of 0.075 mm and under a sieve having a mesh size of 0.5 mm is equal to or more than 30% by mass and equal to or less than 100% by mass.

In addition, in the method for suppressing a blowout of a deep fried food, phosphoric acid crosslinked starch may further be incorporated into the filling.

Furthermore, in the method for suppressing a blowout of a deep fried food, a content of the component A in the filling maybe equal to or more than 0.5% by mass and equal to or less than 8% by mass.

Furthermore, in the method for suppressing a blowout of a deep fried food, a content of the phosphoric acid crosslinked starch in the filling may be equal to or more than 0.1% by mass and equal to or less than 5% by mass.

Moreover, in the method for suppressing a blowout of a deep fried food, a mass of the phosphoric acid crosslinked starch may be equal to or more than 0.1 times and equal to or less than 1 time a mass of the component A.

A composition of the present invention includes a component (A) satisfying conditions of (1) to (4) below, and

phosphoric acid crosslinked starch,

in which a total amount of the component A and the phosphoric acid cross inked starch is equal to or more than 20% by mass and equal to or less than 100% by mass, and a mass of the phosphoric acid crosslinked starch is equal to or more than 0.1 times and equal to or less than 1 time a mass of the component A.

(1) A starch content is equal to or more than a 75% by mass

(2) Molecular weight-reduced starch of starch having an amylose content of equal to or more than 5% by mass is contained in an amount of equal to or more than 3% by mass and equal to or less than 45% by mass, and a peak molecular weight of the molecular weight-reduced starch is equal to or more than 3×10³ and equal to or less than 5×10⁴

(3) A degree of swelling in cold water at 25° C. is equal to or more than 5 and equal to or less than 20

(4) A content on a sieve having a mesh size of 0.075 mm and under a sieve having a mesh size of 0.5 mm is equal to or more than 30% by mass and equal to or less than 100% by mass

A deep fried food of the present invention includes a component A satisfying conditions of (1) to (4) below in a filling.

(1) A starch content is equal to or more than 75% by mass

(2) Equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴

(3) A degree of swelling in cold water at 25° C. is equal to or more than 5 and equal to or less than 20

(4) A content on a sieve having a mesh size of 0.075 mm and under a sieve having a mesh size of 0.5 mm is equal to or more than 30% by mass and equal to or less t an 100% by mass

In addition, the deep fried food may further contain phosphoric acid crosslinked starch in the filling.

Furthermore, in the deep fried food, a content of the component A in the filling may be equal to or more than 0.5% by mass and equal to or less than 8% by mass.

Furthermore, in the deep fried food, a content of the phosphoric acid crosslinked starch in the filling may be equal to or more than 0.1% by mass and equal to or less than 5% by mass.

In addition, in the deep fried food, a mass of the phosphoric acid crosslinked starch may be equal to or more than 0.1 times and equal to or less than 1 time a mass of the component A.

### Advantageous Effects of Invention

A blowout suppressing agent for a deep fried food of the present invention can realize excellent meltability in mouth and can suppress an occurrence of a blowout during frying.

In addition, according to a method for suppressing a blowout of a deep fried food and a deep fried food of the present invention, it is possible to realize excellent meltability in mouth and to provide a deep fried food that is hard to cause a blowout during frying.

### DESCRIPTION OF EMBODIMENTS

Hereinafter, embodiments of a blowout suppressing agent, method for suppressing a blowout of a deep fried food, a deep fried food, and a composition of the present invention will be described.

### 1. Blowout Suppressing Agent

The blowout suppressing agent of the present embodiment contains a component A satisfying conditions of (1) to (4).

(1) A starch content is equal to or more than 75% by mass

(2) Equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴

(3) A degree of swelling in cold water at 25° C. is equal to or more than 5 and equal to or less than 20

(4) A content on a sieve having a mesh size of 0.075 mm and under a sieve having a mesh size of 0.5 mm is equal to or more than 30% by mass and equal to or less than 100% by mass

The conditions of (1) to (4) of the component. A will be described in detail below.

### Condition of (1)

The starch content of the starch according to the condition of (1) is important to be equal to or more than 75% by mass, preferably equal to or more than 85% by mass, more preferably equal to or more than 90% by mass, still more preferably equal to or more than 99% by mass, and still, further preferably equal to or more than 99.5% by mass. As a result, a blowout of a deep fried food can be stably suppressed.

The component A contains the molecular weight-reduced starch according to the condition of (2) .

In addition, as starch other than the molecular weight-reduced starch contained in the component A, one or more of starch such as corn starch, tapioca starch, sweet potato starch, potato starch, wheat starch, and rice starch; and processed starch obtained by processing these starch chemically, physically, or enzymatically can be selected and used. Preferably, one or more starch selected from the group consisting of the corn starch, the wheat starch, the potato starch, the tapioca starch, and crosslinked starch of these may be contained, and more preferably the corn starch may be contained. The content of such starch other than the molecular weight-reduced starch is preferably equal to or more than 50% by mass, more preferably equal to or more than 60% by mass, and still more preferably equal to or more than 75% by mass, in the component A. An upper limit of the content of the starch other than the molecular weight-reduced starch is not limited, and is preferably equal to or less than 100% by mass together with the molecular weight-reduced starch.

### Condition of (2)

As the starch having the amylose content of equal to or more than 5% by mass described in the condition (2), one or more starch selected from the group consisting of a raw material starch such as high amylose corn starch, corn starch, tapioca starch, sweet potato starch, potato starch, wheat starch, high amylose wheat starch, and rice starch; and processed starch obtained by processing the raw material starch chemically, physically, or enzymatically can be used. As the raw material arch, it is preferable to use one or more selected from the high amylose corn starch, the corn starch, and the tapioca starch, and it is more preferable to use the high amylose corn starch. It is important that the raw material starch is starch having a high amylose content in which the amylose content is equal to or more than 5% by mass. The amylose content is preferably equal to or more than 12% by mass, more preferably equal to or more than 22% by mass, still more preferably equal to or more than 45% by mass, still further preferably equal to or more than 60% by mass, and even more preferably equal to or more than 65% by mass. As a result, a blowout of a deep fried food can be stably suppressed and excellent meltability in mouth can be obtained.

In addition, the molecular weight-reduced starch according to the condition of (2) can be obtained by reducing a molecular weight by decomposing one or more kinds of starch selected from the group consisting of raw material starch and processed starch. The molecular weight-reduced starch is preferably obtained by reducing the molecular weight of the raw material, starch. As the decomposition treatment, an acid treatment, an oxidation treatment, an enzyme treatment or the like can be adopted, and it is more preferable to adopt the acid treatment from the viewpoint of a decomposition rate or costs and reproducibility of a decomposition reaction.

A condition of the acid treatment is not limited, and for example, the acid treatment can be performed as follows. After adding the starch having a high amylose content and water to a reaction device, and acid is further added. Alternatively, acid water, in which an inorganic acid is previously dissolved in water, and the starch as a raw material are added to the reaction device. From a viewpoint of more stably performing the acid treatment, it is desirable that a total amount of the starch in the reaction is in a state of being uniformly dispersed in an aqueous phase or in a slurry state. For the purpose, a concentration of the starch slurry in the acid treatment is adjusted to be in a range, for example, equal to or more than 10% and equal to or less than 50%, and preferably equal to or more than 20% and equal to or less than 40%. When the slurry concentration is too high, slurry viscosity may increase, and it may be difficult to stir the slurry uniformly, in some cases.

Specific examples of the acid used for the acid treatment include inorganic acids such as hydrochloric acid, sulfuric acid, and nitric acid, which can be used regardless of a kind, purity, and the like.

In the acid treatment reaction, for example, a concentration of the inorganic acid during the acid treatment is preferably equal. to or more than 0.05 Normality (N) and equal to or less than 4 N, more preferably equal to or more than 0.1 N and equal to or less than 4 N, and still more preferably equal to or more than 0.2 N and equal to or less than 3 N. Also, a reaction temperature is preferably equal to or ha her than 30° C. and equal to or lower than 70° C., more preferably equal to or higher than 35° C. and equal to or lower than 70° C., and still more preferably equal to or higher than 35° C. and equal to or lower than 65° C. A reaction time is preferably equal to or longer than 0.5 hours and equal to or shorter than 120 hours, more preferably equal to or longer than 1 hour and equal to or shorter than 72 hours, and still more preferably equal to or longer than 1 hour and equal to or shorter than 48 hours.

Furthermore, it is important that the molecular weight-reduced starch has peak molecular weight of equal to or more than 3×10³ and equal to or less than 5×10⁴. As a result, a blowout of a deep fried food can be stably suppressed and excellent meltability in mouth can be obtained. From the same viewpoint, a lower limit of the peak molecular weight is preferably equal to or more than 8×10³. An upper limit of the peak molecular weight is preferably equal to or less than 3×10⁴, and more preferably equal to or less than 1.5×10⁴.

### Method for Measuring Peak Molecular Weight

The peak molecular weight of the molecular weight-reduced starch can be measured by a measuring device and a measuring method below.

### Measuring Device

HPLC unit: manufactured by Tosoh Corporation

Pump: DIP-8020

RI detector: RS-8021

Degassing device: SD-8022

Filtration filter: DISMIC-25HP PTFE 0.45 μm, manufactured by ADVANTEC

### Measuring Method

1. A sample is pulverized and prepared to have a mesh size of equal to or smaller than 0.15 mm according to the JIS-Z8801-1 standard. The sample was suspended in a mobile phase so as to be 1 mg/mL, and the suspension was heated at 100° C. for 3 minutes to completely dissolve Filtration is performed using a 0.45 μm filtration filter, and a filtrate is obtained as an analytical sample.

2. A molecular weight is measured under the following analysis conditions.

### Analysis Condition

Column: Two columns of TSKgel α-M (7.8 mmφ, 30 cm), manufactured by Tosoh Corporation

Flow rate: 0.5 mL/min

Mobile phase: 5 mM MaNO₃-containing dimethyl sulfoxide solution at 90% (v/v)

Column temperature: 40° C.

Analytical volume: 0.2 mL

3. The detector data was collected by software (multi-station GPC-8020 model II data collection ver 5.70, manufactured by Tosoh Corporation), and the molecular weight peak was calculated. For a calibration curve, Pullulan with a known molecular weight (Shodex Standard P-82, manufactured by Showa Denko KK) is used.

Also, the content of the molecular weight-reduced starch in the component A is important to be equal to or more than 3% by mass and equal to or less than 45% by mass, preferably equal to or more than 8% by mass and equal to or less than 45% by mass, more preferably equal to or more than 12% by mass and equal to or less than 35% by mass, and still more preferably equal to or more than 15% by mass and equal to or less than 25% by mass. As a result, a blowout of a deep fried food can be stably suppressed and excellent meltability in mouth can be obtained.

From the same viewpoint, the content of the molecular weight-reduced starch in the component A is equal to or more than 3% by mass, preferably equal to or more than 8% by mass, more preferably equal to or more than 12% by mass, and still more preferably equal to or more than 15% by mass, and is equal to or less than 45% by mass preferably equal to or less than 35% by mass, and more preferably equal to or less than 25% by mass.

### Condition of (3)

It is important that the degree of swelling in cold water at 25° C. according to the condition of (3) is equal to or more than 5 and equal to or less than 20. Also, a lower limit of the degree of swelling in cold water is preferably equal to or more than 6, and more preferably equal to or more than 6.5. Also, an upper limit of the degree of swelling in cold water is preferably equal to or less than 17, and more preferably equal to or less than 15. When the degree of swelling in cold water is lower than the above range, meltability in mouth of a deep fried food will, be poor, contrariwise, when the degree of swell in in cold water is too high a sufficient blowout suppressing effect cannot be obtained.

### Method For Measuring Degree of Swelling in Cold Water

The degree of swelling in cold water can be measured by a method of (a) to (f) below.

(a) A sample is heated and dried at 130° C. to measure a moisture, and the amount of the dry substance is calculated from an obtained moisture value.

(b) 1 g of the sample in terms of the amount of a dry substance is stirred at 25° C. for 30 minutes in a state of being dispersed in 50 mL of water at 25° C.

(c) After stirring, the mixture is centrifuged for 10 minutes by a centrifugal separation method in which a relative centrifugal force calculated from formula (1) below is 1609.92 (xg), and is separated into a sediment layer and a supernatant layer.

(1) Relative centrifugal force (xg)=1118×Centrifugal radius (cm)×(Rotation speed (rpm))²×10⁻⁸

(d) The supernatant layer is removed, the mass of the sediment layer is measured, and this mass is set as B (g).

(e) The mass when the sediment layer is dried and solidified (105° C., constant weight) is set as C (g).

(f) A value obtained by dividing B by C is set as the degree of swelling in cold water.

### Condition of (4)

In a particle size of the component A according to the condition of (4), a content on a sieve having a mesh size of 0.075 mm and under a sieve having a mesh size of 0.5 mm according to JIS-Z-8801-1 standard is important to be equal to or more than 30% by mass and equal to or less than 100% by mass, preferably equal to or more than 40% by mass and equal to or less than 100% by mass, more preferably equal to or more than 50% by mass and equal to or less than 100% by mass, and still more preferably equal to or more than 60% by mass and equal to or less than 100% by mass. As a result, a blowout of a deep fried food can be stably suppressed and excellent meltability in mouth can be obtained. From the same viewpoint, it is also preferable that in the component A, the content on a sieve having a mesh size of 0.18 mm and under a sieve having a mesh size of 0.25 mm is equal to or more than 5% by mass and equal to or less than 30% by mass.

Here, regarding the particle size of the component A, a content of a fraction on or under the sieve is a content of the fraction with respect to the entirety of the component A.

Also, the component A is specifically a granulated product or a pulverized product thereof.

### Method for Preparing Component A

The component A satisfying the conditions of (1) to (4) described above can be obtained by the following method.

A method for producing the component A includes a step of reducing a molecular weight of t e starch having the amylose content of equal to or more than 5% by mass by the method described above to obtain a molecular weight-reduced starch having a peak molecular weight of equal to or more than 3×10³ and equal to or less than 5×10⁴, and a step of pregelatinizing a raw material in which equal to or more than 3% by mass and equal to or less than 45% by mass of molecular weight-reduced starch is contained and a total of the molecular weight-reduced starch and starch other than the molecular weight-reduced starch is equal to or more than 75% by mass. Also, as needed, it is preferable to perform a step of pulverizing a pregelatinized product of the raw material and a step sieving a pulverized product of the pregelatinized product of the raw material so that the content on a sieve having a mesh size of 0.075 mm and under a sieve having a mesh size of 0.5 mm is equal to or more than 30% by mass to 100% by mass.

In the step of pregelatinization, a general method used for heat gelatinization of starch can be used. Specifically, a heat gelatinization method using a machine such as a drum dryer, a jet cooker, an extruder, or a spray dryer is known. In the present embodiment, from the viewpoint of obtaining the component. A in which the degree of swelling in cold water at 25° C. satisfies the condition of (3) described above, the heat gelatinization with the extruder or the drum dryer is appropriate, and the extruder is most appropriate.

In the case of an extruder treatment, usually, after adding water to a raw material containing starch to prepare the moisture content to be equal to or more than 10% by mass and equal to or less than 60% by mass, for example, the heat gelatinization is performed in a conditions at a barrel temperature of equal to or higher than 30° C. and equal to or lower than 200° C., at an outlet temperature of to or higher than 80° C. and equal to or lower than 180° C., at a screw rotation speed of equal to or more than 100 rpm and equal to or less than 1,000 rpm for a heat treatment time of equal to or longer than 5 seconds to equal to or shorter than 50 seconds.

The step of pulverizing the pregelatinized product of the raw material and the step of sieving are not limited as long as the method is capable to obtain the component A satisfying the condition of (4), and a known apparatus and a method can be used needed.

Also, although not related to the effect of the invention, the component A may contain an insoluble salt in addition to the starch described above, and calcium carbonate is preferable as the insoluble salt. The calcium carbonate is preferably contained in the component A in an amount of equal to or more than 0.1% by mass and equal to or less than 2% by mass.

### Content of Component A

A lower limit of the content of the component A in the blowout suppressing agent of the present embodiment is preferably equal to or more than 50% by mass, more preferably equal to or more than 55% by mass, still more preferably equal to or more than 60% by mass, and still further preferably equal to or more than 65% by mass. As a result, it possible to further improve the meltability in mouth of a deep fried foods. Here, the content of the component A in the blowout suppressing agent is with respect to an entirety of the blowout suppressing agent. An upper limit of the content of the component A in the blowout suppressing agent of the present embodiment is not limited, and when the phosphoric acid crosslinked starch is contained, it is preferable that the total of the component A and the phosphoric acid crosslinked starch is 100% by mass.

### Phosphoric Acid Crosslinked Starch

In addition, it is preferable that the blowout suppressing agent of the present embodiment contains the phosphoric acid crosslinked starch. The starch raw material of the phosphoric acid crosslinked starch is not limited, and one or more from the group consisting of corn starch, tapioca starch, sweet potato starch, potato starch, wheat starch, and rice starch can be selected and used, and preferably, one or more selected from the group consisting of the corn starch, the tapioca starch, and the potato starch are selected and used, and it is more preferable to use the potato starch. As a result, a blowout of a deep fried food can be further stably suppressed and excellent meltability in mouth can be obtained. A method for producing the phosphoric acid crosslinked starch is not limited, and a known method can be appropriately selected for production. Since the phosphoric acid crosslinked starch is inevitably pregelatinized in a production process of a deep fried food, it is not necessary to use a special pregelatinized product, and pregelatinized phosphoric acid crosslinked starch is preferably used.

### Content of Phosphoric Acid Crosslinked Starch

In the phosphoric acid crosslinked starch in the blowout suppressing agent, the mass of the phosphoric acid crosslinked starch is preferably a content to be equal to or more than 0.1 times or and equal to or less than 1 time the mass of the component A, more preferably is equal to or more than 0.1 times or and equal to or less than 0.9 times, still more preferably equal to or more than 0.15 times or and equal to or less than 0.8 times, still further preferably equal to or more than 0.15 times or and equal to or less than 0.75 times, and even more preferably equal to or more than 0.2 times and equal to or less than 0.65 times. As a result, a balance between the effect of suppressing the blowout and the effect of improving meltability in mouth in a deep fried food can further be improved.

From the same viewpoints, in the blowout suppressing anent, the mass of the phosphoric acid crosslinked arch is preferably equal to or more than 0.1 times the mass of the component A, more preferably equal to or more than 0.15 times, and still more preferably equal to or more than 0.2 times, and preferably equal to or less than 0.9 times, and more preferably equal to or less than 0.8 times, still more preferably equal to or less than 0.75 times, and still further preferably equal to or less than 0.65 times.

Also, a total mass of the component A and the phosphoric acid crosslinked starch in the blowout suppressing agent of the present embodiment is preferably equal to or more than 85% by mass and equal to or less than 100% by mass, more preferably equal to or more than 90% by mass and equal to or less than. 100% by mass, and still more preferably equal to or more than 95% by mass and equal to or less than 100% by mass. As a result, a blowout of a deep fried food can be further stably suppressed and excellent meltability in mouth can be obtained.

Here, the total mass is a total mass with respect to the entirety of the blowout suppressing agent.

The blowout suppressing agent of the present embodiment is added to a filling of a deep fried food such as a cream croquette, a potato croquette, a curry bread, and a deep fried pie so that, for example, the component A is contained in an amount of equal to or more than 0.5% by amass and equal to or less than 8% by mass. As a result, excellent meltability in mouth can be obtained, and a blowout during frying can be suppressed. The amount of the blowout suppressing agent added to the deep fried food is set such that the component A with respect to the filling of the deep fried food is preferably equal to or more than 1% by mass and equal to or less than 5% by mass, more preferably equal to or more than 1.5% by mass and equal to or less than 4% by mass, and still further preferably equal to or more than 1.5% by mass and equal to or less than 3.5% by mass, from the viewpoint of improving the meltability in mouth of the deep fried food.

From the same viewpoint, the amount of the component A added to the filling of the deep fried food is, for example, equal to or more than 0.5% by mass, preferably equal to or more than 1% by mass, and more preferably equal to or more than 1.5% by mass, and is, for example, equal to or less than 8% by mass, preferably equal to or less than 5% by mass, more preferably equal to or less than 4% by mass, and still more preferably equal to or less than 3.5% by mass.

Here, the content of the component A is the amount of the component A with respect to the entirety of the filling.

Also, the blowout suppressing agent of the present embodiment may further contain other components, in addition to the component A and the phosphoric acid crosslinked starch, within a range not impairing the effects of the present invention. Examples of the other components include sugars such as sugar; proteins such as gluten; cereals such as a soybean flour; polysaccharides such as pectin and other gums; oils and fats; pigments; emulsifiers; and insoluble salts such as calcium carbonate and calcium sulfate.

According to the blowout suppressing agent of the present embodiment, when adding the blowout suppressing agent to the filling of the deep fried food such as a cream croquette, a potato croquette, a curry bread, and a deep fried pie, it is possible to realize the excellent meltability in mouth and to suppress the occurrence of the blowout during frying.

### 2.l Method for Suppressing Blowout

In the method for suppressing a blowout of the present embodiment, the component A satisfying the conditions of (1) to (4) below is incorporated into the filling of the deep fried food such as the cream croquette, the potato croquette, the curry bread, and the deep fried pie. Details of the conditions of (1) to (4) are the same as those described in the above 1. Blowout suppressing agent, and thus will not be repeated.

(1) starch content is equal to or more than 75% by mass

(2) Molecular weight-reduced starch of starch having an amylose content of equal to or more than 5% by mass is contained in an amount of equal to or more than 3% by mass and equal to or less than 45% by mass, and a peak molecular weight of the molecular weight-reduced starch is equal to or more than 3×10³ and equal to or less than 5×10⁴

(3) A degree of swelling in cold water at 25° C. is equal to or more than 5 and equal to or less than 20

(4) A content on a sieve having a mesh size of 0.075 mm and under a sieve having a mesh size of 0.5 mm is equal to or more than 30% by mass and equal to or less than 100% by mass

The content of the component A in the filling is preferably equal to or more than 0.5% by mass and equal to or less than 8% by mass, more preferably equal to or more than 0.5% by mass and equal to or less than 5% by mass, still more preferably equal to or more than 1% by mass and equal to or less than 5% by mass, still further preferably equal to or more than 1.5% by mass and equal to or less than 4% by mass, and even more preferably equal to or more than 1.5% by mass and equal to or less than 3.5% by mass. As a result, a balance between the effect of suppressing the blowout and the effect of improving meltability in mouth in a deep fried food can further be improved.

The content of the component A in the filling for example, equal to or more than 0.5% by mass, preferably equal to or more than 1% by mass, and more preferably equal to or more than. 1.5% by mass, and is, for example, equal to or less than 8% by mass, preferably equal to or less than 5% by mass, more preferably equal to or less than 4% by mass, and still more preferably equal to or less than 3.5% by mass.

Here, the content of the component A with respect to the filling is the amount of the component A with respect to the entirety of the filling.

In addition, it is preferable that the method for suppressing a blowout of the present embodiment preferably includes further incorporating the phosphoric acid crosslinked starch into the filling. As a result, a more excellent blowout suppressing effect can be exhibited Details of the phosphoric acid crosslinked starch are the same as those described in the above <Phosphoric acid crosslinked starch> of 1. Blowout suppressing agent, and thus will not be repeated.

The content of the phosphoric acid crosslinked starch in the filling is preferably equal to or more than 0.1% by mass and equal to or less than 5% by mass, more preferably equal to or more than 0.1% by mass and equal to or less than 2% by mass, still more preferably equal to or more than 0.2% by mass and equal to or less than 1.8% by mass, still further preferably equal to or more than 0.3% by mass and equal to or less than 1.6% by mass, and even more preferably equal co or more than 0.4% by mass and equal to or less than 1.5% by mass. As a result, a balance between the effect of suppressing the blowout and the effect of improving meltability in mouth in a deep fried food can further be improved.

From the same viewpoint, the content of the phosphoric acid crosslinked starch in the filling is preferably equal to or more than 0.1% by mass, more preferably equal to or more than 0.2% by mass, still more preferably equal to or more than 0.3% by mass, and still further preferably equal to or more than 0.4% by mass, and is preferably equal to or less than 5% by mass, more preferably equal to or less than 2% by mass, still more preferably equal to or less than 1.8% by mass, still further preferably equal to or less than 1.6% by mass, and even more preferably equal to or less than 1.5% by mass.

Here, the content of the phosphoric acid crosslinked starch in the filling is the amount of the phosphoric acid crosslinked starch with respect to the entirety of the filling.

According to the method for suppressing a blowout of the present embodiment, it is possible to realize the excellent meltability in mouth for the cream croquette, the potato croquette, the curry bread, the deep fried pie, and the like, and to effectively suppress the occurrence of the blowout during frying.

### 3. Composition

In the method for suppressing a blowout of the present embodiment, it is preferable to prepare a composition in which at least the component A and the phosphoric acid crosslinked starch are previously mixed, and then the composition is added to the filling. In the composition, a total amount of the component A and the phosphoric acid crosslinked starch is important to be equal to or more than 20% by mass and equal to or less than 100% by mass, and is preferably equal to or more than 50% by mass and equal to or less than 100% by mass, and more preferably equal to or more than 70% by mass and equal to or less than 100% by mass. As a result, a blowout of a deep fried food can be further stably suppressed and excellent meltability in mouth can be obtained.

Here, the total amount is a total amount of the component A and the phosphoric acid crosslinked starch with respect to the entirety of the composition.

In the composition, the mass of the phosphoric acid crosslinked. starch is preferably a content to be equal to or more than 0.1 times or and equal to or less than 1 time the mass of component A, more preferably is equal to or more than 0.1 times or and equal to or less than 0.9 times, still more preferably equal to or more than 0.15 times or and equal to or less than 0.8 times, still further preferably equal to or more than 0.15 times or and equal to or less than 0.75 times, and even more preferably equal to or more than 0.2 times and equal to or less than 0.65 time. As a result, a balance between the effect of suppressing the blowout and the effect of improving meltability in mouth in a deep fried food can further be improved.

From the same viewpoint, in the composition, the content of the phosphoric acid crosslinked starch in the filling is preferably equal to or more than 0.1 times by mass the component A, more preferably equal to or more than 0.15 times by mass, and still more preferably equal to or more than 0.2 times by mass, and is preferably equal to or less than 1 time by mass, more preferably equal to or less than 0.9 times by mass, still more preferably equal to or less than 0.8 times by mass, still further preferably equal to or less than 0.75 times by mass, and even more preferably equal to or less than 0.65 times by mass.

Also, the composition of the present embodiment may further contain other components, in addition to the component A and the phosphoric acid crosslinked starch, within a range not impairing the effects of the present invention. Examples of the other components include seasonings such as a salt and consomme; milk powders of skim milk and the like; sugars such as a sugar; proteins such as gluten and gelatin; cereal flours such as a soybean flour and a wheat flour; polysaccharides such as pectin and other gums; oils and fats; pigments; emulsifiers; and insoluble salts such as calcium carbonate and calcium sulfate.

### 4. Deep Fried Food

The deep fried food of the present embodiment contains a component satisfying conditions of (1) to (4) below in a filling. it is noted that details of the conditions of (1) to (4) are the same as those described in the above 1. Blowout suppressing agent, and thus will not be repeated.

(1) A starch content is equal to or more than 75% by mass

(2) Molecular weight-reduced starch of starch having an amylose content of equal to or more than 5% by mass is contained in an amount of equal to or more than 3% by mass and equal to or less than 45% by mass, and a peak molecular weight of the molecular weight-reduced starch is equal to or more than 3×10³ and equal to or less than 5×10⁴

(3) A degree of swelling in cold water at 25° C. is equal to or more than 5 and equal to or less than 20

(4) A content on a sieve having a mesh size of 0.075 mm and under a sieve having a mesh size of 0.5 mm is equal to or more than 30% by mass and equal to or less than 100% by mass

In the deep fried food, the content of the component A in the filling is preferably equal to or more than 0.5% by mass and equal to or less than 8% by mass, more preferably equal to or more than 0.5% by mass and equal to or less than 5% by mass, still more preferably equal to or more than 1% by mass and equal to or less than 5% by mass, still further preferably equal to or more than 1.5% by mass and equal to or less than 4% by mass, and even more preferably equal to or more than 1.5% by mass and equal to or less than 3.5% by mass. As a result, the excellent meltability in mouth can be obtained and a blowout during frying can be more stably suppressed.

From the same viewpoint, the content of the component A in the filling of the deep fried food is preferably equal to or more than 0.5% by mass, more preferably equal to or more than 1% by mass, and still more preferably equal to or more than 1.5% by mass, and is preferably equal to or less than 8% by mass, more preferably equal to or less than 5% by mass, still more preferably equal to or less than 4% by mass, and still further preferably equal to or less than 3.5% by mass.

In addition, it is preferable that the deep fried food of the present embodiment contains the phosphoric acid crosslinked starch in the filling. Details of the phosphoric acid crosslinked starch are the same as those described in the above <Phosphoric acid crosslinked starch> of 1. Blowout suppressing agent, and thus will not be repeated.

In the deep fried food, the content of the phosphoric acid crosslinked starch in the filling is preferably equal to or more than 0.1% by mass and equal to or less than 5% by mass, more preferably equal to or more than 0.1% by mass and equal to or less than 2% by mass, still more preferably equal to or more than 0.2% by mass and equal to or less than 1.8% by mass, still further preferably equal to or more than 0.3% by mass and equal to or less than 1.6% by mass, and even more preferably equal to or more than 0.4% by mass and to or less than 1.5% by mass. As a result, a balance between the effect of suppressing the blowout and the effect of improving meltability in mouth in a deep fried food can further be improved.

From the same viewpoint, in the deep fried food, the content of the phosphoric acid crosslinked starch in the filling is preferably equal to or more than 0.1% by mass, more preferably equal to or more than 0.2% by mass, still more preferably equal to or more than 0.3% by mass, and still further preferably equal to or more than 0.4% by mass, and is preferably equal to or less than 5% by mass, more preferably equal to or less than 2% by mass, still more preferably equal to or less than 1.8% by mass, and still further preferably equal to or less than 1.5% by mass.

Regarding the component. A and the phosphoric acid crosslinked starch in the deep fried food, the mass of the phosphoric acid crosslinked starch is preferably equal to or more than 0.1 times or and equal to or less than 1 time the mass of the component A, more preferably is equal to or more than 0.15 times or and equal to or less than 0.9 times, still more preferably equal to or more than 0.2 times or and equal to or less than 0.85 times, and still further preferably equal to or more than 0.25 times or and equal to or less than 0.75 times. As a result, a balance between the effect of suppressing the blowout and the effect of improving meltability in mouth in a deep fried food can further be improved.

From the same viewpoints, in the deep fried food the mass of the phosphoric acid crosslinked starch is preferably equal to or more than 0.1 times the mass of the component A, more preferably equal to or more than 0.15 times, still more preferably equal to or more than 0.2 times, and still further preferably equal to or more than 0.25 times, and is preferably equal to or less than 1 time, more preferably equal to or less than 0.9 times, still more preferably equal to or less than 0.85 times, and still further preferably equal to or less than 0.75 times.

The mass of the phosphoric acid crosslinked starch in the deep fried food is preferably a content to be equal to or more than 0.1 times or and equal to or less than 1 time the component A in the deep fried food, more preferably is equal to or more than 0.1 times or and equal to or less than 0.9 times, still more preferably equal to or more than 0.15 times or and equal to or less than 0.8 times, still further preferably equal to or more than 0.15 times or and equal to or less than 0.75 times, and even more preferably equal to or more than 0.2 times and equal to or less than 0.65 time.

The method for producing a deep fried food includes a step of preparing a filling by mixing the component A or the composition containing the component A and the phosphoric acid crosslinked starch, and a step of frying the filling.

Examples of the deep fried food of the present embodiment include croquettes such as a cream croquette, a potato croquette, and a pumpkin croquette; fried breads such as a curry bread and a cheese fried bread; and deep fried pies such as an apple pie, a chocolate pie, and a custard pie.

According to the deep fried food of the present embodiment, it is possible to realize the excellent meltability in mouth and it is possible to provide deep fried foods such as a cream croquette, a potato croquette, a curry bread, and a deep fried pie, which have excellent appearance because the blowout does not occur when frying.

### EXAMPLES

Hereinafter, specific examples of the blowout suppressing agent, the method for suppressing a blowout, the deep fried food, and the composition or the present invention will be described.

### Preparation of Acid-Treated High Amylose Corn Starch

A method for preparing the acid-treated high amylose corn starch as the molecular weight-reduced starch will by described.

High amylose corn starch (amylose content of 70% by mass, manufactured by J-OIL MILLS, INC.) was suspended in water to prepare 35.6% (w/w) slurry, and was heated to 50° C., A reaction was started by adding an aqueous hydrochloric acid solution prepared to be 4.25 N in an amount of 1/9 times in terms of a weight ratio of the slurry while stirring. After reacting for 16 hours, it was neutralized with 3% NaOH, washed with water, dehydrated, and dried to obtain acid-treated high amylose corn starch. In this case, the peak molecular weight of the acid-treated high amylose corn starch was 1.2×10⁴.

### Preparation of Component A

The method for preparing the component A used in the present example will be described.

79% by mass of corn starch (amylose content of 25% by mass, manufactured by J-OIL MILLS, INC.), 20% by mass of acid-treated high amylose corn starch obtained by the above method, and 1% by mass of calcium carbonate (COLLOCALSO-Ex, manufactured by Shiraishi Calcium Kaisha, Ltd.) were mixed in a bag to be sufficiently uniform. A mixture was heat-treated under pressure using a twin-screw extruder (KEI-45 manufactured by Kowa Industry Co., Ltd.). Processing conditions are follows.

Raw material supply: 450 g/min

Water addition: 17% by mass

Barrel temperature: 50° C., 70° C., and 100° C. from the raw material inlet to the outlet

Outlet temperature: 100° C. to 110° C.

Screw rotation speed of 250 rpm

A pregelatinized product obtained by the extruder treatment in this manner was dried at 110° C. to adjust the moisture content to 10% by mass.

Next, the dried pregelatinized product was pulverized with a desktop cutter pulverizer and then sieved using a sieve of JIS-Z8801-1 standard. The sieved pregelatinized product was mixed at the following blending ratios to prepare the component A.

On a sieve having a mesh size of 0.5 mm: 18% by mass

Under a sieve with a mesh size of 0.5 mm, and on a sieve with a mesh size of 0.25 mm: 42% by mass

Under a sieve with a mesh size of 0.25 mm, and on a sieve with a mesh size of 0.18 mm: 13% by mass

Under a sieve with a mesh size of 0.18 mm, and on a sieve with a mesh size of 0.075 mm: 22% by mass

Under a sieve having a mesh size of 0.075 mm: 5% by mass

The degree of swelling in cold water of the component A was measured by the above method, as a result, was 10.5.

### Example 1

A cream croquette before frying was prepared using a material for a filling shown in Table 1 and a material for batter shown in Table 2 below, and fried obtain the cream croquette. In the present example, the blowout suppressing effect during frying and a texture were examined. Numerical values of each material in Table 1 are on the basis of % by mass. In addition, numerical values of each material in Table 2 are on the basis of part(s) by mass.

TABLE 1

| | | | Compar- | Compar- | Compar- |
|---|---|---|---|---|---|
| | | | ative | ative | ative |
| | | Example | Example | Example | Example |
| | | 1 | 1-1 | 1-2 | 1-3 |
| Powder | Component A | 2.0 | | | |
| raw | Starch 1 | | 2.0 | | |
| mate- | Starch 2 | | | 2.0 | |
| rial | Starch 3 | | | | 2.0 |
| | Roasted | 3.0 | 3.0 | 3.0 | 3.0 |
| | flour *¹ | | | | |
| | Gelatin *² | 1.0 | 1.0 | 1.0 | 1.0 |
| | Skim milk *³ | 1.4 | 1.4 | 1.4 | 1.4 |
| | Table salt | 0.6 | 0.6 | 0.6 | 0.6 |
| | White sugar | 1.5 | 1.5 | 1.5 | 1.5 |
| | Consomme *⁴ | 0.8 | 0.8 | 0.8 | 0.8 |
| Other | Margarine | 5.0 | 5.0 | 5.0 | 5.0 |
| raw | Canola oil *⁵ | 2.0 | 2.0 | 2.0 | 2.0 |
| mate- | Onion | 17.0 | 17.0 | 17.0 | 17.0 |
| rials | Cold milk | 65.7 | 65.7 | 65.7 | 65.7 |

^{*1} Roasted flours are fried soft flours on low heat until a volume is reduced by 10%
^{*2} Gelatin (Gelatin AU, manufactured by Zerais Co., Ltd.)
^{*3} Skim milk (Skim milk powder, manufactured by Yotsuba Milk Products Co., Ltd.)
^{*4} Consomme (Ajinomoto KK Consomme, manufactured by Ajinomoto Co., Inc.)
^{*5} Canola oil (Sara-sara canola oil (smooth canola oil), manufactured by J-Oil Mills Co., Ltd.)

### Starch 1 to 3

Details of starch 1 to 3 in Table 1 will be described below.

Starch 1: Pregelatinized product. of phosphoric acid crosslinked potato starch (Bake-up B-α, manufactured by J-Oil Mills Co., Ltd.)

Starch 2: Pregelatinized product of hydroxypropylated phosphoric acid crosslinked corn starch (Jelcall G-α, manufactured by J-Oil Mills Co., Ltd.)

Starch 3 Pregelatinized product of waxy corn starch (Alpha Waxy Starch, manufactured by J-Oil Mills Co., Ltd.)

TABLE 2
Batter liquid

| | |
|---|---|
| Water | 70 |
| Batter mixed flour | 15 |
| Rice flour | 3 |
| Canola oil *⁵ | 17 |
| Thickener preparation *⁶ | 0.11 |

Bread crumbs

| | |
|---|---|
| First bread crumbs *⁷ | 100 |
| Second bread crumbs *⁸ | 100 |

^{*6} Thickener preparation (Minute W, manufactured by DSP Gokyo Food & Chemical Co., Ltd.)
^{*7} First bread crumbs (FRYSTAR Fine Bread Crumbs, manufactured by Frystar Co., Ltd., using under a sieve when sieved with a sieve having a mesh size of 0.71 mm
^{*8} Second bread crumbs (FRYSTAR Fine Bread Crumbs, manufactured by Frystar Co., Ltd., using on a sieve when sieved with a sieve having a mesh size of 0.71 mm

### Method for Preparing Cream Croquette Before Frying

A cream croquette before frying was prepared by the following procedures of (a) to (f).

(a) Margarine was added to chopped onions and fried without burning until clear.

(b) The remaining raw materials were added (cold milk was added last) and stirred until uniform.

(c) It was heated to be thicken so as not to burn.

(d) After refrigerating at 4° C. and solidifying into a jelly, the mixture was divided into 25 g×6 pieces, molded, and frozen at −20° C. for 16 hours.

(e) After applying a batter liquid shown in Table 2, the first bread crumbs were attached, the batter liquid was applied again, and then the second bread crumbs were attached thereto.

(f) The cream croquette before frying was obtained by freezing at −20° C. for 4 hours.

### Evaluation Method

An evaluation of the blowout suppressing effect was performed on a total of 6 cream croquettes obtained by frying the cream croquettes before frying by 3 pieces at 175° C. for 8 minutes. Table 3 shows results of the number of blowouts, a degree of blowouts, and a texture evaluation of each sample. For the texture evaluation, evaluation results were determined by the consensus of two specialized panelists. In addition, the “blowout” in the present evaluation means a state in which the batter of the cream croquette was cracked or torn during frying, and when the state deteriorates, the filling was in a state of popping out. In addition, as a preliminary test, a total of 6 cream croquettes in which the component A and the starch 1 to 3 were not contained in the filling were fried. As a result, blowouts occurred in all the samples.

TABLE 3

| | | Compar- | Compar- | Compar- |
|---|---|---|---|---|
| | | ative | ative | ative |
| | Example | Example | Example | Example |
| | 1 | 1-1 | 1-2 | 1-3 |
| Number of | 2 | 0 | 3 | 6 |
| blowouts | | | | |
| (Total 6) | | | | |
| Degree of | Small crack | No blowout | Large crack | Very large |
| blowout | was observed, | | was formed | crack was |
| | and filling | | and leakage | observed |
| | was leaking | | of filing was | |
| | very slightly. | | noticeable. | |
| Texture | Smooth | Gel-like, | Smooth | Smooth |
| evaluation | and good | hard, and poor | and good | and good |
| | in meltability | in meltability | in meltability | in meltability |
| | in mouth | in mouth | in mouth | in mouth |

As shown in Table 3, from the results of the number of blowouts, the blowout suppressing effect was observed in the cream croquettes of Example 1 and Comparative Examples 1-1 and 1-2. However, in the cream croquette of Comparative Example 1-2 which had a blowout, a large amount of filling leaked from the blowout portion. In the cream croquette of Comparative Examples 1-3, the blowout suppressing effect was not observed. Regarding the texture evaluation, the cream croquettes of Example 1 and Comparative Example 1-2 had a smooth texture and had an excellent meltability in mouth, whereas the cream croquettes of Comparative Example 1-1 were gel-like, hard, and poor in meltability in mouth.

From the results in Table 3, it was found that when incorporating 2.0% by mass of the component A into the filling of the cream croquette, it was possible to realize the excellent meltability in mouth and effectively suppress the occurrence of the blowout during frying.

### Example 2

In the present example, the blowout suppressing effect and the texture when further using the starch 1 in combination with the filling of the cream croquette of Example 1 were examined. The filling of the cream croquette before frying used in the present example was prepared by preparing a composition in advance by mixing the roasted flours, the component A, the starch 1, gelatin, skim milk, table salts, a white sugar, and the consomme at the blending ratios shown in Table 4, and then through the steps of (a) to (f) above. The prepared cream croquette before frying was divided into 3 pieces each and fried in two parts at 175° C. for 8 minutes to obtain a total of 6 cream croquettes. Table 5 shows the number of blowouts during frying and the results of texture evaluation. For the texture evaluation, the same method as the evaluation method described in Example 1 was used. Numerical values of each component in Table 4 are on the basis of % by mass.

TABLE 4

| | | Example | Example | Example | Example |
|---|---|---|---|---|---|
| | | 1 | 2-1 | 2-2 | 2-3 |
| Powder | Component A | 2.0 | 2.0 | 2.0 | 2.0 |
| raw | Starch 1 | | 0.5 | 1.0 | 1.5 |
| mate- | Roasted | 3.0 | 3.0 | 3.0 | 3.0 |
| rial | flour *¹ | | | | |
| | Gelatin *² | 1.0 | 1.0 | 1.0 | 1.0 |
| | Skim milk *³ | 1.4 | 1.4 | 1.4 | 1.4 |
| | Table salt | 0.6 | 0.6 | 0.6 | 0.6 |
| | White sugar | 1.5 | 1.5 | 1.5 | 1.5 |
| | Consomme *⁴ | 0.8 | 0.8 | 0.8 | 0.8 |
| Other | Margarine | 5.0 | 5.0 | 5.0 | 5.0 |
| raw | Canola oil *⁵ | 2.0 | 2.0 | 2.0 | 2.0 |
| mate- | Onion | 17.0 | 16.8 | 16.7 | 16.6 |
| rials | Cold milk | 65.7 | 65.4 | 65.0 | 64.6 |

TABLE 5

| | Example | Example | Example | Example |
|---|---|---|---|---|
| | 1 | 2-1 | 2-2 | 2-3 |
| Number of | 2 | 0 | 0 | 0 |
| blowouts | | | | |
| (Total 6) | | | | |
| Texture | Smooth | Smooth | Slightly | Gel-like |
| evaluation | and good | and good | gel-like | but having |
| | in meltability | in meltability | but having | meltability |
| | in mouth | in mouth | smooth | in mouth |
| | | | meltability | without any |
| | | | in mouth | problem |

As shown in Table 5, from the results of the number of blowouts, in the cream croquettes of Examples 2-1 to 2-3, no blowout was observed during frying. From the result, it was found that a more excellent blowout suppressing effect can be obtained by incorporating the component A and the phosphoric acid crosslinked potato starch (starch 1) to the filling, as compared with the cream croquette of Example 1.

Moreover, from the evaluation result of the texture, the cream croquette of Example 1 and the cream croquettes of Examples 2-1 and 2-2 were smooth and had good texture in meltability in mouth. The cream croquette of Example 2-3 had a gel feeling, but had meltability in mouth without any problem. From this result, it was found that

both the cream croquette of Example 1 and the cream croquette of Examples 2-1 to 2-3 had excellent meltability in mouth.

From the results in Table 5, it was found that when incorporating 2.0% by mass of the component. A and equal to or more than 0.5% by mass and equal to or less than 1.5% by mass of the phosphoric acid crosslinked potato starch into the filling of the cream croquette, it was possible to realize the good meltability in mouth and effectively suppress the occurrence of the blowout during frying. Furthermore, it was found that excellent meltability in mouth can be realized by setting the content of the phosphoric acid crosslinked potato starch to be less than 1.5% by mass.

### Example 3

In addition, a curry bread, an apple pie, and a custard pie, in which 2% by mass of the component A and 1% by mass of the phosphoric acid crosslinked potato starch (starch 1) were incorporated into the filling were prepared, respectively, and the presence or absence of the blowout during frying and the texture were evaluated. As a result, it was confirmed that all of the curry bread, the apple pie, and the custard pie achieved excellent meltability in mouth and had the blowout suppressing effect during frying.

### Example 4

In the present example, a composition was obtained by mixing the component A and the starch 1 by setting the mass of the starch 1 to be 0.1, 0.2, 0.4, 0.65, 0.8, and 1 time the mass of component A. Furthermore, when a cream croquette in which 3% by mass of each composition was incorporated into the filling was prepared, all of the cream croquettes had an excellent appearance without blowout and had a good meltability in mouth.

The blowout suppressing agent, the method for suppressing a blowout, the deep fried food, and the composition of the present invention are not limited to the above-described embodiments and examples, and various modifications can be made within the range not impairing the effects of the present invention.

Priority is claimed on Japanese Patent plication No. 2018-151334, filed on Aug. 10, 2018, the entire disclosure of which is incorporated herein.

1. A blowout suppressing agent for a deep fried food, comprising:
a component A satisfying conditions of (1) to (4) below,
(1) a starch content is equal to or more than 75% by mass,
(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴,
(3) a degree of swelling in cold water at 25° C. is equal to or more than 5 and equal to or less than 20, and
(4) a content on a sieve having a mesh size of 0.075 mm and under a sieve having a mesh size of 0.5 mm is equal to or more than 30% by mass and equal to or less than 100% by mass.

2. The blowout suppressing agent according to claim 1, further comprising:
phosphoric acid crosslinked starch.

3. The blowout suppressing agent according to claim 2,
wherein a mass of the phosphoric acid crosslinked starch is equal to or more than 0.1 times and equal to or less than 1 time a mass of the component A.

4. A method for suppressing a blowout of a deep fried food, the method comprising:
incorporating a component A satisfying conditions of (1) to (4) below into a filling of the deep fried food,
(1) a starch content is equal to or more than 75% by mass,
(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴,
(3) a degree of swelling in cold water at 25° C. is equal to or more than 5 and equal to or less than 20, and
(4) a content on a sieve having a mesh size of 0.075 mm and under a sieve having a mesh size of 0.5 mm is equal to or more than 30% by mass and equal to or less than 100% by mass.

5. The method according to claim 4,
wherein phosphoric acid crosslinked starch is further incorporated into the filling.

6. The method according to claim 4,
wherein a content of the component A in the filling is equal to or more than 0.5% by mass and equal to or less than 8% by mass.

7. The method according to claim 5,
wherein a content of the phosphoric acid crosslinked starch in the filling is equal to or more than 0.1% by mass and equal to or less than 5% by mass.

8. The method according to claim 5,
wherein a mass of the phosphoric acid crosslinked starch is equal to or more than 0.1 times and equal to or less than 1 time a mass of the component A.

9. A composition comprising:
a component (A) satisfying conditions of (1) to (4) below; and
phosphoric acid crosslinked starch,
wherein a total amount of the component A and the phosphoric acid crosslinked starch is equal to or more than 20% by mass and equal to or less than 100% by mass, and
a mass of the phosphoric acid crosslinked starch is equal to or more than 0.1 times and equal to or less than 1 time a mass of the component A,
(1) a starch content is equal to or more than 75% by mass,
(2) molecular weight-reduced starch of starch having an amylose content of equal to or more than 5% by mass is contained in an amount of equal to or more than 3% by mass and equal to or less than 45% by mass, and a peak molecular weight of the molecular weight-reduced starch is equal to or more than 3×10³ and equal to or less than 5×10⁴,
(3) a degree of swelling in cold water at 25° C. is equal to or more than 5 and equal to or less than 20, and
(4) a content on a sieve having a mesh size of 0.075 mm and under a sieve having a mesh size of 0.5 mm is equal to or more than 30% by mass and equal to or less than 100% by mass.

10. A deep fried food comprising:
a component A satisfying conditions of (1) to (4) below in a filling,
(1) a starch content is equal to or more than 75% by mass,
(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴,
(3) a degree of swelling in cold water at 25° C. is equal to or more than 5 and equal to or less than 20, and
(4) a content on a sieve having a mesh size of 0.075 mm and under a sieve having a mesh size of 0.5 mm is equal to or more than 30% by mass and equal to or less than 100% by mass.

11. The deep fried food according to claim 10, further comprising:
phosphoric acid crosslinked starch in the filling.

12. The deep fried food according to claim 10,
wherein a content of the component A in the filling is equal to or more than 0.5% by mass and equal to or less than 8% by mass.

13. The deep fried food according to claim 11,
wherein a content of the phosphoric acid crosslinked starch in the filling is equal to or more than 0.1% by mass and equal to or less than 5% by mass.

14. The deep fried food according to claim 11,
wherein a mass of the phosphoric acid crosslinked starch is equal to or more than 0.1 times and equal to or less than 1 time a mass of the component A.
